(19) United States
(12) Patent Application Publication
(10) Pub. No.: US 2007/0132200 A1
(43) Pub. Date: Jun. 14, 2007

(54) MOVEABLE SHELF AND SUPPORT THEREFORE

(76) Inventors: Kunio Miyazaki, Kumamoto-shi (JP); Tomoyuki Kawano, Kumamoto-shi (JP); Ichiro Ikenega, Kumamoto-shi (JP); Michihiko Higashinosono, Kumamoto-shi (JP); Takuya Nakamura, Kumamoto-shi (JP); Hiroyuki Kiyota, Kumamoto-shi (JP); Kazuya Tokunaga, Kumamoto-shi (JP)

Correspondence Address: Ernest A. Beutler;Attorney at Law, 10 Rue Marseille, Newport Beach, CA, 92660, US

(21) Appl. No.: 11/674,614

(22) Filed: Feb. 13, 2007

Related U.S. Application Data
(62) Division of application No. 10/248,686, filed on Feb. 9, 2003.

(30) Foreign Application Priority Data
Aug. 23, 2002 (JP) 2002-243984

(51) Int. Cl. B62B 1/00

(52) U.S. Cl. 280/79.3

(57) ABSTRACT

A number of embodiments of moveable storage racks and/or partitions that can be installed in existing buildings without the necessity of installing guide rails for them. In addition, the movement may be controlled so that the partitions move either in a parallel fashion or they can be rotated through an arc. The partitions are supported on drive and guide belts that are mounted on the underside thereof and which eliminate the need for the guide rails and spread the weight of the partition over a greater area of the floor so as to permit use in buildings which were not originally designed for such systems.

### CROSS REFERENCE TO RELATED APPLICATION

This application is a division of our co-pending application, entitled MOVEABLE SHELF AND PARTITIONING SYSTEM, Ser. No. 10/248,686, filed Feb. 9, 2003 and assigned to the assignee hereof.

### DETAILED DESCRIPTION

This invention relates to a moveable shelf and support therefore that offers greater flexibility and versatility than those presently in use.

There are known storage systems that include one or more moveable shelves that are supported for movement along a work area on tracks or guide rails that are affixed to the floor of the area. When there are a plurality of these shelves, they can be compressed in abutting relationship to open up space and then moved to offer access to the individual shelf areas for the insertion and removable of articles therefrom. These types of devices have wide application and considerable utility.

However, the requirement for having rails or tracks in the floor by which the shelves can be moved means that the area must be specially adapted to utilize this type of system. Also, once converted to this arrangement, the utility of the area is somewhat compromised.

In addition, once in position the types of moveable shelves aforedescribed are not easily moved to another location. If they are to be moved, then that location must also be modified to provide the necessary guide rails on which the shelves can be mounted.

It is, therefore, a principal object to this invention to provide an improved moveable shelf arrangement that does not require guide rails for its operation.

It is a further object to this invention to provide a moveable shelf that can be supported on any type of floor and can be freely moved from position to position to optimize space utilization.

It is a still further object of the invention to provide an improved moveable base system for such shelves that will offer a predictable movement along a floor of any conventional type including carpeted ones that will insure parallel movement of the individual shelves.

### SUMMARY OF THE INVENTION

A first feature of the invention is adapted to be embodied in a storage arrangement comprising a shelf adapted to receive articles. The shelf has a base and a drive unit disposed beneath the base and adapted to support the shelf on a floor for movement there along. Each drive unit is comprised of pairs of transversely spaced wheels supported for rotation upon the base about parallel, spaced axes. Each drive unit includes a support belt trained around the wheels and having a lower flight for engaging the floor and supporting the shelf thereupon. At least drive unit further includes a drive for rotating at least one of the wheels for driving the belt and effecting movement of the shelf along the floor.

### BRIEF DESCRIPTION OF DRAWINGS

FIG. 1 is a side elevational view of a moveable partitioning and shelving system constructed in accordance with a first embodiment of the invention.

FIGS. 2, 3 and 4 are bottom views of the supporting frame for the shelf shown in FIG. 1 looking at the left-hand edge, the center and the right-hand edge, respectively.

FIGS. 5, 6 and 7 are side elevational views of the frame supporting portion showing the same areas illustrated in FIGS. 2, 3 and 4, respectively.

FIG. 8 is a top plan view showing two pairs of drive belts.

FIG. 9 is a side elevational view of the drive belts.

FIG. 10 is a view, in part similar to FIG. 9, but only shows one drive belt and in another type of arrangement therefore.

FIG. 11 is a cross sectional view taken along the line 11-11 of FIG. 10.

FIG. 12 is a view, in part similar to FIG. 9, and shows another embodiment of the invention and illustrates the arrangement supported on the floor.

FIG. 13 is a graphical view showing how the driving load depends upon the width of the drive belt.

FIG. 14 is an enlarged view, in part similar to FIG. 10, and shows how the drive belt supports the shelving and acts as a cushion between the driving wheels and the floor.

FIG. 15 is a view, in part similar to FIG. 3, but shows another embodiment of the invention.

FIG. 16 is a view looking in the direction of the arrow 16 in FIG. 15.

FIG. 17 is a view looking the direction of the arrow 17 in FIG. 15 and is in part similar to FIG. 6.

### DETAILED DESCRIPTION

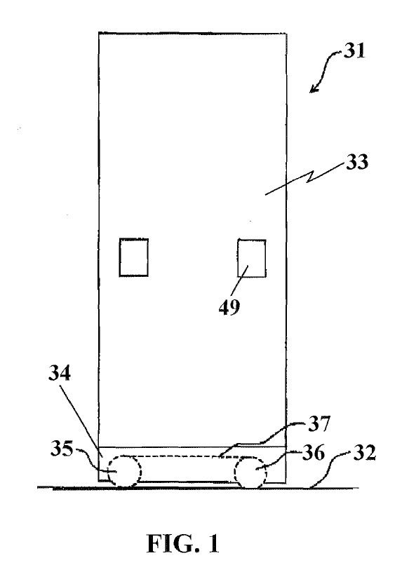

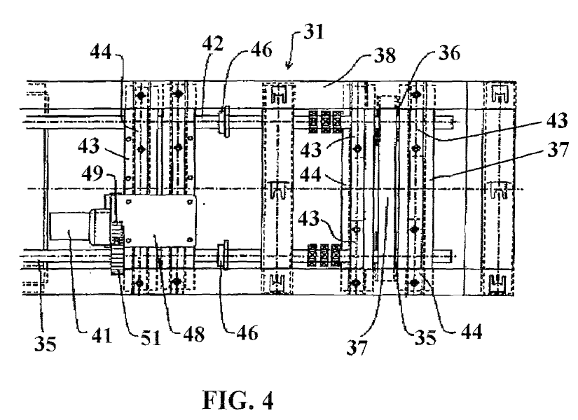

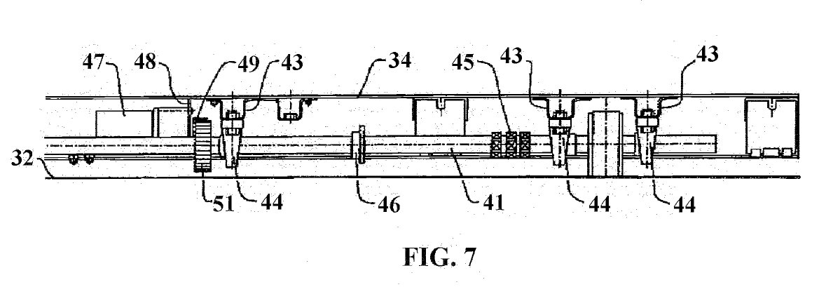

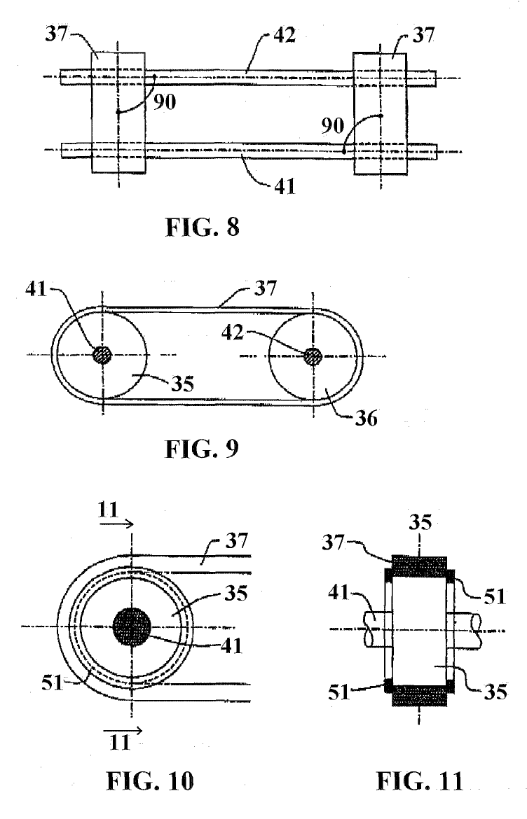

Referring now in detail to the drawings and initially to the embodiment of FIGS. 1 through 9 and beginning by specific reference to FIG. 1, a moveable shelf constructed in accordance with this embodiment of the invention is identified generally by the reference numeral 31. The moveable shelf 31 is adapted to be supported for movement along a floor 32 of any common type in a manner to be described.

The shelf 31 includes an upper shelf assembly 33 that is mounted on a base, indicated generally by the reference numeral 34. The shelf assembly 33 can be of any material and construction and, for example, can include adjustable shelves that are held by side pieces. Since those skilled in the art will readily understand the various forms that the shelving may take, further description of that is believed to be unnecessary.

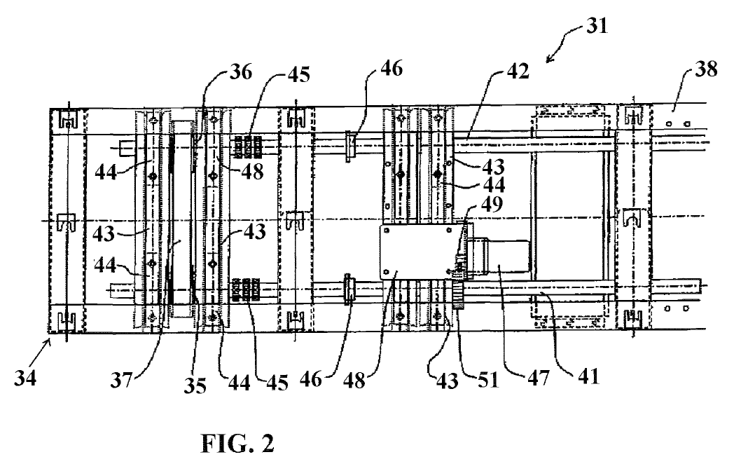

The base 34 has a construction as best shown and as will be described later by reference to FIGS. 2 through 7. However, it includes driving wheels 35 and driven wheels 36 that are interconnect by an endless belt 37 which provides the direct support for the shelf 31 on the floor 32.

Referring now primarily to FIGS. 2 through 6, the base 34 is comprised of a sheet metal assembly comprised of a planar type upper surface 38 and a pair of folded down side surfaces. Reinforcing U-channels 39 may be affixed at spaced locations along the horizontal surface 38 to add rigidity to the construction. A driving shaft 41 and driven shaft 42 are journaled in spaced transverse relationship by means of a plurality of pillow blocks 43 that are affixed to and form a part of the base 34. Specifically, these pillow blocks 43 are fixed to the under side of the panel surface 38. Bearings 44 carried by these pillow blocks 43 complete the journaling of the shafts 41 and 42 in the base 34.

The driving wheels 35 are affixed at spaced locations and between pairs of the pillow blocks 43 and bearings 44 to the driving shaft 41. In a like manner, the driven wheels 36 are affixed to the driven shaft 42. In order to facilitate assembly and machining, the shafts 41 and 42 need not be continuous shafts but can constitute shaft segments that are joined together by couplings 45.

The drive belts 37 may be of the toothed type and can cooperate with sprocket teeth on the driving wheels 35 and driven wheels 36. In addition and if desired, a plurality of sprockets 46 may be fixed along the lengths of the shafts 41 and 42 and interconnected by a chain (not shown).

The driving shaft 41 is driven by one or more electric motors 47 that are mounted on a mounting bracket assembly 48 on the underside of the plate 38. These electric motors 47 have pinion gears 49 affixed to their drive shafts. The pinion gears 49 cooperate with gears 51 fixed to the driving shaft 41 so as to drive it. These motors 47 are of the reversible variable speed type and are control by a suitable control panel 49 mounted on the side of the shelves 31 (FIG. 1).

Although the drive belts 37 may be made of any suitable material and may, as noted above, have their inner flight toothed to provide a non-slip driving relationship with the driving wheels 35 and driven wheel 36, it may be desirable to provide an arrangement for retaining the drive belt against axial movements. FIGS. 10 and 11 show an embodiment to how this may be accomplished. Aside from this anti-slipping arrangement, the construction is the same as that previously described and, therefore, the components which are the same have been identified by the same reference numerals and will not be described again, except insofar as is necessary to understand the construction and operation of this embodiment.

In this embodiment, the driving and driven wheels 35 and 36 have annular members 51 affixed to their outer periphery and which extend radially outwardly beyond the outer periphery of the wheels 35 and 36. Thus, as seen in FIG. 1, these extending portions provided by the annular members 51 will insure that the belts 37 are maintained in axial position on the wheels 35 and 36.

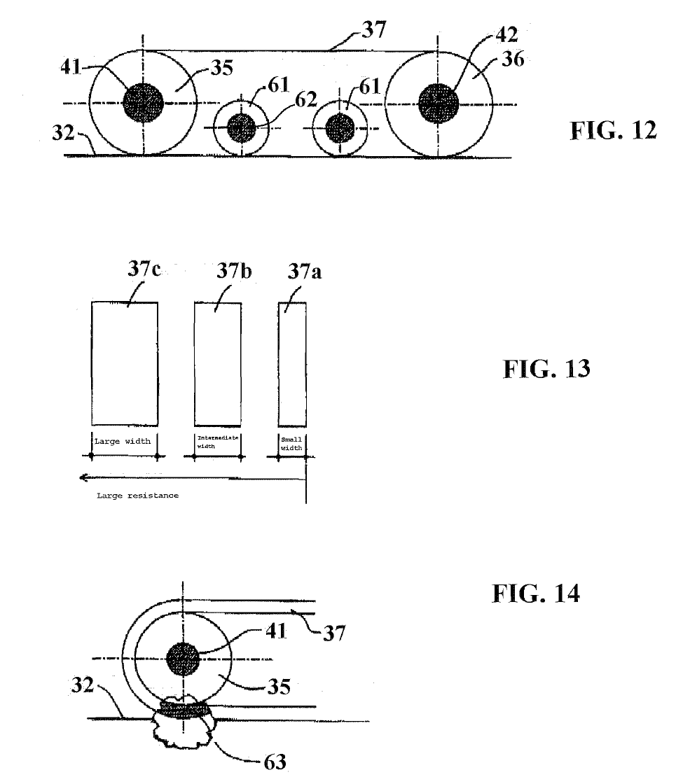

Depending upon the width or depth of the shelves 31, it may be desirable to provide further support on the floor 32 and specifically for the back up side of the belt 37. FIG. 12 shows such an arrangement where, in addition to the driving wheel 35 and driven wheel 36 mounted on the shafts 41 and 42, respectively, there are a plurality of back up rollers 61 that are carried by shafts 62 that are journaled in the pillow blocks 43 and bearings 44. Thus, more back up contact is provided between the drive belt 37 and the floor 32.

Also, the width of the belts 37 may be changed from a narrow width to a wide width as shown in FIG. 13 where the different widths are shown at 37a, 37b and 37c. Although the support is greater when the width is increased, this provides a larger resistance to driving and requires larger driving motors.

FIG. 14 shows how the inter-positioning of the belt 37 between the driving and driven wheels 35 and 36 and the floor 32 provides a cushioning between the wheels 35 and 36 and the floor 32. Hence, the device can be utilized on a wide variety of floor materials and, special rails embedded in or mounted on the floor 32 are not required. The supporting portion of the drive belt is indicated in FIG. 14 by the reference numeral 63.

It has been noted in the embodiment as thus far described, there are provided two electric drive motors 47 spaced transversely across the length of the shelf 31. Of course, the number of drive motors can be changed. Also although electric motors are illustrated, other means for rotating the driving shaft 41 can be employed. These can include providing a manual crank handle mounted on the side of shelf 31 for rotating the shaft 41.

In the embodiment as thus far described, all of the drive wheels 35 are mounted on a common shaft and are driven. Depending upon the loads to be expected and the specific environment, it is not necessary that all wheels be directly driven.

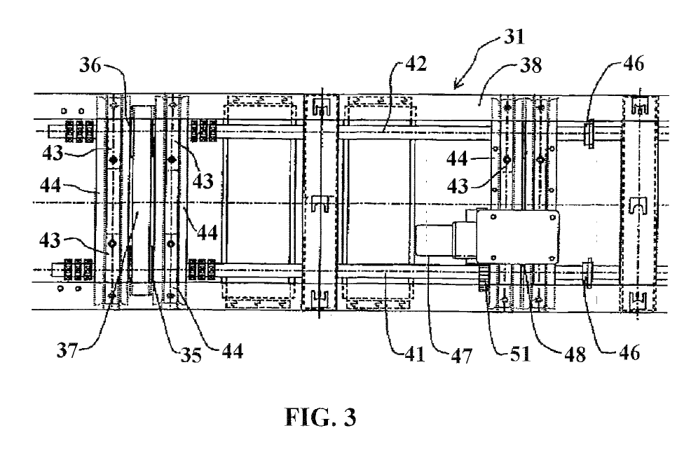

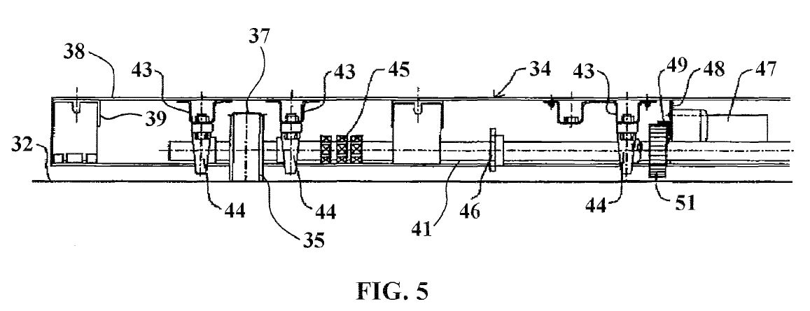

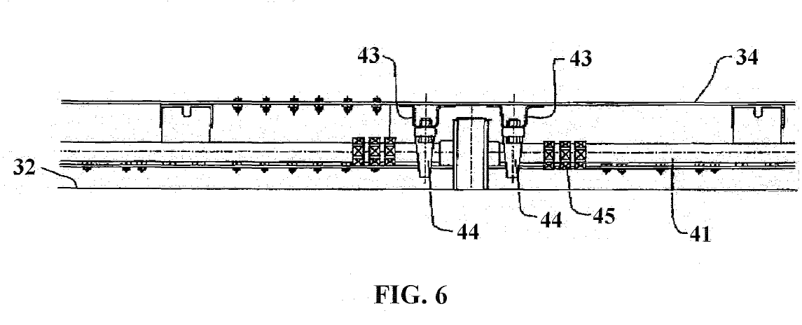

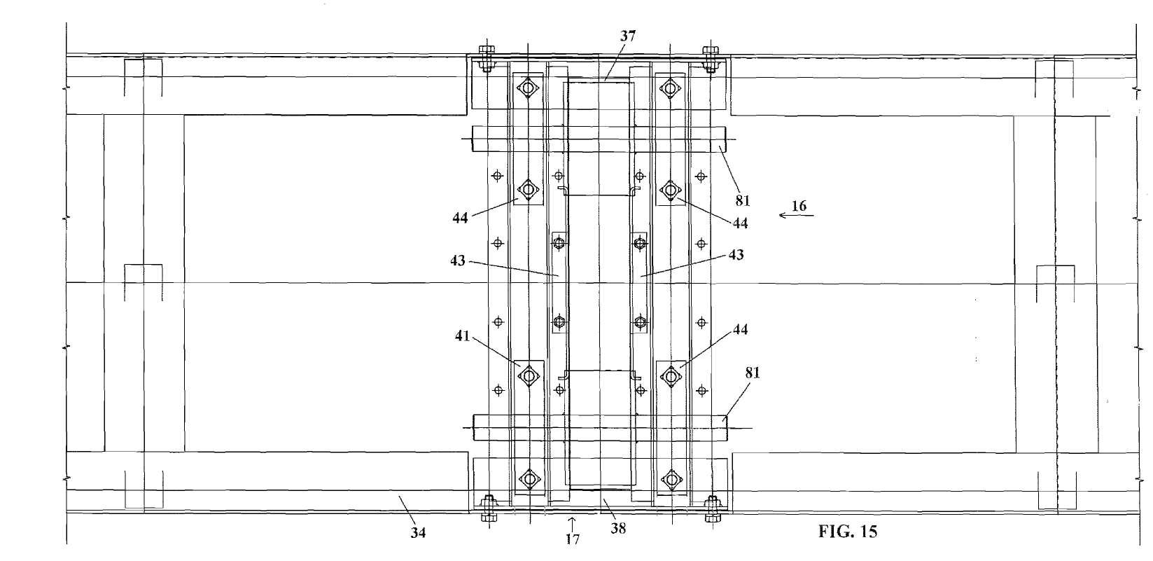

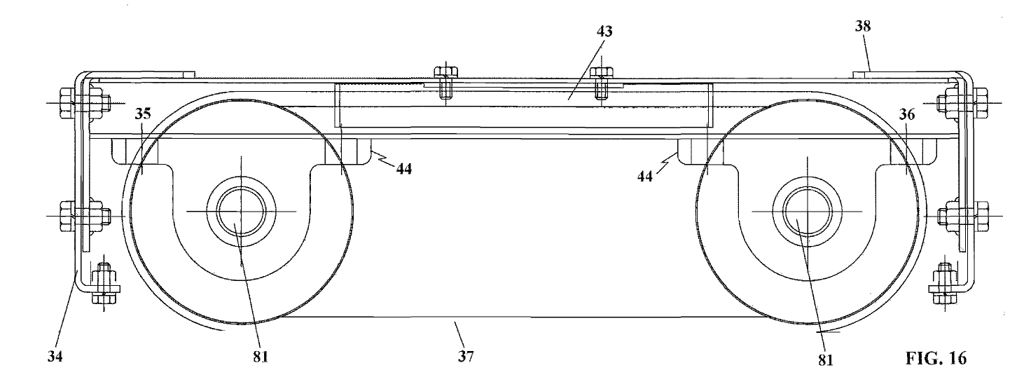

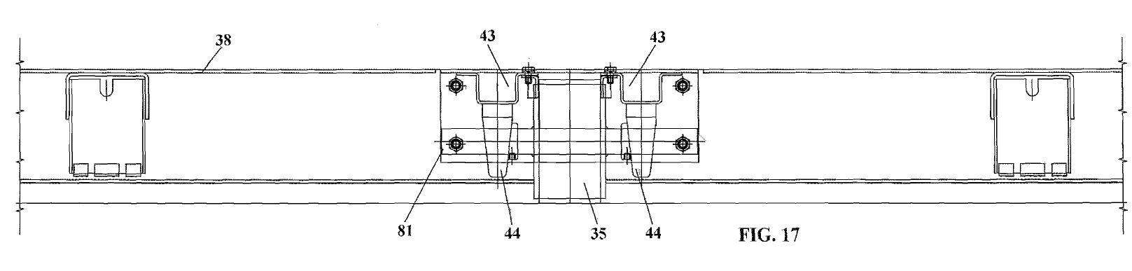

FIGS. 15 through 17 are partial views which can be considered to be similar to FIGS. 3 and 6 and show how some wheels, again indicated by the reference numerals 35 and 36, can be mounted on stub shafts 81 which are journaled in the pillow blocks 43 and bearings 44. In this case, these drive belts 37 are only driven through their contact with the floor.

In connection with an arrangement wherein the driving wheels that are driven by an electrical motor or other force are not all coupled to each other, it would be possible to provide controls whereby one motor can be driven and the other remains stationary or is rotated in a reverse direction. In this way, it is actually possible for the shelf to be driven in an arcuate fashion. The possibilities of such various movements should be readily apparent to those skilled in the art without further description or illustration.

Thus, from the foregoing description it should be readily apparent that the described embodiments permit the use of storage devices that can be easily moved and employed in any closed area without the necessity of guide rails. This offers substantially greater versatility and a wider variety of types of storage systems. Of course, the foregoing description is that of preferred embodiments of the invention and various changes and modifications may be made without departing from the spirit and scope of the invention, as defined by the appended claims.

1. A storage arrangement comprising a shelf adapted to receive articles, said shelf having a base, a drive unit disposed beneath said base and adapted to support said shelf on a floor for movement there along, said drive unit being comprised of a pair of wheels supported for rotation upon said base about parallel, spaced axes, a drive and support belt trained around said wheels and having a lower flight for engaging the floor and supporting said shelf thereupon, and a drive for rotating at least one of said wheels for driving said belt and effecting movement of said shelf along the floor.

2. A storage arrangement as set forth in claim 1 wherein the base further supports a back up member engaging at least a portion of the side of the lower flight between the area engaged with the pair of wheels that does not engage the floor for providing additional support for the shelf on the floor.

3. A storage arrangement as set forth in claim 2 wherein the back up member comprises at least one additional wheel.

4. A storage arrangement as set forth in claim 3 wherein the back up member comprises a plurality of additional wheels.

5. A storage arrangement as set forth in claim 1 further including an additional pair of wheels supported for rotation upon said base about parallel, spaced axes and a further support belt trained around said additional pair of wheels and having a lower flight for engaging the floor and supporting said shelf thereupon.

6. A storage arrangement as set forth in claim 5 further including a second drive for driving at least one of the additional wheels.

7. A storage arrangement as set forth in claim 5 wherein the additional pair of wheels and further support belt are transversely spaced from the first mentioned pair of wheels and support belt.

8. A storage arrangement as set forth in claim 7 further including a third pair of wheels supported for rotation upon said base about parallel, spaced axes, and a third support belt trained around said third pair of wheels and having a lower flight for engaging the floor and supporting said shelf thereupon said third pair of wheels and said third support belt being transversely spaced from the first mentioned pair of wheels and support belt and from the additional pair of wheels and additional support belt.

9. A storage arrangement as set forth in claim 8 further including a second drive for driving at least one of the additional wheels.

10. A storage arrangement as set forth in claim 9 wherein the third pair of wheels and third support belt is disposed transversely between the first pair of wheels and the additional pair of wheels and is not directly driven.

11. A storage arrangement as set forth in claim 10 wherein the first mentioned drive and the second drive are independently operated to effect rotation of the shelf about the floor.
